(19) United States
(12) Patent Application Publication
(10) Pub. No.: US 2006/0216434 A1
(43) Pub. Date: Sep. 28, 2006

(54) Polymer dispersed liquid crystal device and method of manufacturing the same

(75) Inventors: Masafumi Okuyama, Miyagi-ken (JP); Naoki Ito, Miyagi-ken (JP); Akihiro Shinada, Miyagi-ken (JP)

Correspondence Address: BEYER WEAVER & THOMAS, LLP, P.O. BOX 70250, OAKLAND, CA, 94612-0250, US

(73) Assignee: ALPS ELECTRIC CO., LTD.

(21) Appl. No.: 11/369,426

(22) Filed: Mar. 6, 2006

(30) Foreign Application Priority Data
Mar. 25, 2005 (JP) 2005-087620

(51) Int. Cl. C09K 19/38; C09K 19/52; G02F 1/1333

(52) U.S. Cl. 428/1.1; 252/299.01; 349/86

(57) ABSTRACT

Syrup in which photo-curable resins and liquid crystals are compound is injected into a liquid crystal cell, and then ultraviolet rays are radiated to the liquid crystal cell to harden the photo-curable resins through photo polymerization. In this case, a material for fluorescing by ultraviolet rays is added to the syrup.

### BACKGROUND OF THE INVENTION

1. Field of the Invention

The present invention relates to a polymer dispersed liquid crystal device using a PDLC, a HPDLC or the like and a method of manufacturing the same.

2. Description of the Related Art

A polymer dispersed liquid crystal device using a polymer dispersed liquid crystal (PDLC) or a holographic polymer dispersed liquid crystal has been developed recently. For example, the PDLC display device includes a liquid crystal cell having a polymer dispersed liquid crystal layer in which the liquid crystals are dispersed in polymers and which is interposed between a pair of substrates. The PDLC display device displays picture images by varying transmittance of light components passing through the liquid crystal cell from a light scattering state without applying voltage to a light transmitting state with applying voltage. Furthermore, since the PDLC display device does not require orientation of the liquid crystals or polarizers, the PDLC display device can increase light use efficiency and display brighter picture images than those in the conventional liquid crystal display device such as a TN (Twisted Nematic) liquid crystal. In addition, the HPDLC display device is a hologram device that can vary the diffraction efficiency of light from a light transmitting state without applying voltage to a light diffraction state with applying voltage, and the above-mentioned polymer dispersed liquid crystal layer has a fine periodic array (diffraction grating) structure formed by liquid crystals and polymers.

When the polymer dispersed liquid crystal device is manufactured, a mixed liquor (referred to as syrup) of liquid crystals and non-hardened photo-curable resins is injected into the liquid crystal cell and then ultraviolet rays are radiated to the liquid crystal cell to harden the photo-curable resins through photo polymerization, thereby forming the polymer dispersed liquid crystal layer. Specifically, in the above-mentioned PDLC display device, the polymer dispersed liquid crystal layer in which the liquid crystals are dispersed in the hardened photo-curable resins is formed by overall exposure for uniformly radiating ultraviolet rays to the entire surface of the liquid crystal cell into which the syrup is injected. Meanwhile, in the above-mentioned HPDLC device, the polymer dispersed liquid crystal layer in which the liquid crystals and the hardened photo-curable resins are periodically arrayed is formed by two-beam interference exposure for radiating two beams (that is, ultraviolet rays) to the entire surface of the liquid crystal cell into which the syrup is injected while the two beams interfere with each other.

Meanwhile, the photo-curable resins are liquid, which include a photo polymerization material called as acrylate or methacrylate based monomers or oligomer, and a photo polymerization initiator for absorbing ultraviolet rays as main components. Since the photo polymerization material has not so high absorbability of ultraviolet rays, it is necessary that the photo polymerization initiator absorb ultraviolet rays to excite the photo polymerization material, in order to initiate the photo polymerization reaction of the photo polymerization material.

For this reason, in the conventional polymer dispersed liquid crystal device, when ultraviolet rays are radiated to the liquid crystal cell into which the syrup is injected, ultraviolet rays having very high energy are required. In addition, since the liquid crystals or the photo polymerization initiator in the syrup absorbs ultraviolet rays, there has been a problem that long time is required to harden the photo-curable resins.

Furthermore, there has been JP-A-7-270761 as a known document related to the invention.

A method of manufacturing a liquid crystal cell, which uses transparent substrates having high ultraviolet transmittance to polymerize a photo polymerization material in a mixed liquor, is disclosed in JP-A-7-270761. However, although the method disclosed in JP-A-7-270761 can suppress attenuate of ultraviolet rays by the substrates, ultraviolet rays as strong as those in the related art need to be radiated to the liquid crystal cell into which the syrup is injected.

### SUMMARY OF THE INVENTION

The invention has been made to solve the above-mentioned problem, and it is an object of an aspect of the invention to provide a polymer dispersed liquid crystal device, which can harden photo-curable resins with smaller energy and in a shorter time and be manufactured in considerably reduced time, and a method of manufacturing the same.

In order to achieve the object, a polymer dispersed liquid crystal device according to the invention includes a liquid crystal cell in which the circumference of a pair of substrates is sealed by a sealant; and a polymer dispersed liquid crystal layer that has photo-curable resins and liquid crystals, and is provided between the pair of substrates of the liquid crystal cell. The photo-curable resins and liquid crystals are polymerized and hardened by a light component having a first wavelength. In this case, the polymer dispersed liquid crystal layer contains a material for fluorescing by a light component having a second wavelength.

In addition, the first wavelength and the second wavelength are equal to each other.

Further, the polymer dispersed liquid crystal layer has a structure in which the liquid crystals are dispersed in the hardened photo-curable resins.

Furthermore, the polymer dispersed liquid crystal layer has a structure in which the liquid crystals and the hardened photo-curable resins are periodically arrayed.

A method of manufacturing a polymer dispersed liquid crystal device according to the invention includes a step of radiating a light component having a first wavelength to a liquid crystal cell in which a mixed liquor of liquid crystals and non-hardened photo-curable resins is injected between a pair of substrates; and a step of forming a polymer dispersed liquid crystal layer, which includes hardened photo-curable resins and the liquid crystals, by hardening the photo-curable resins through photo polymerization. In this case, the mixed liquor contains a material for fluorescing by a light component having a second wavelength.

In addition, the first wavelength and the second wavelength are equal to each other.

Further, the polymer dispersed liquid crystal layer in which the liquid crystals are dispersed in the hardened photo-curable resins is formed by performing overall exposure with light components having the first and second wavelengths.

Furthermore, the polymer dispersed liquid crystal layer in which the liquid crystals and the hardened photo-curable resins are periodically arrayed is formed by performing interference exposure with light components having the first and second wavelengths.

### BRIEF DESCRIPTION OF THE DRAWINGS

FIG. 1 is a cross-sectional view showing the structure of a HPDLC device according to the invention;

FIG. 2 is an enlarged view schematically showing a polymer dispersed liquid crystal layer;

FIG. 3 is a schematic view illustrating the operation of the HPDLC device;

FIG. 4 is a perspective view showing the appearance of a mobile phone;

FIG. 5 is a schematic view showing the inner structure of a panel unit;

FIG. 6 is a schematic view showing the structure of a light path switch;

FIG. 7 is a cross-sectional view showing the structure of a PDLC device according to the invention;

FIG. 8 is a graph showing the relationship between the ultraviolet irradiation time and the light transmittance in a first example and a first comparative example;

FIG. 9 is a graph showing the relationship between the ultraviolet exposure power and the diffraction efficiency in a second example and a second comparative example; and

FIG. 10 is a graph showing the relationship between the ultraviolet irradiation time and the light transmittance in a third and a fourth examples and a third comparative example.

### DESCRIPTION OF THE PREFERRED EMBODIMENT

Hereinafter, a polymer dispersed liquid crystal device and a method of manufacturing the same according to the invention will be described in detail with reference to the drawings.

### First Embodiment

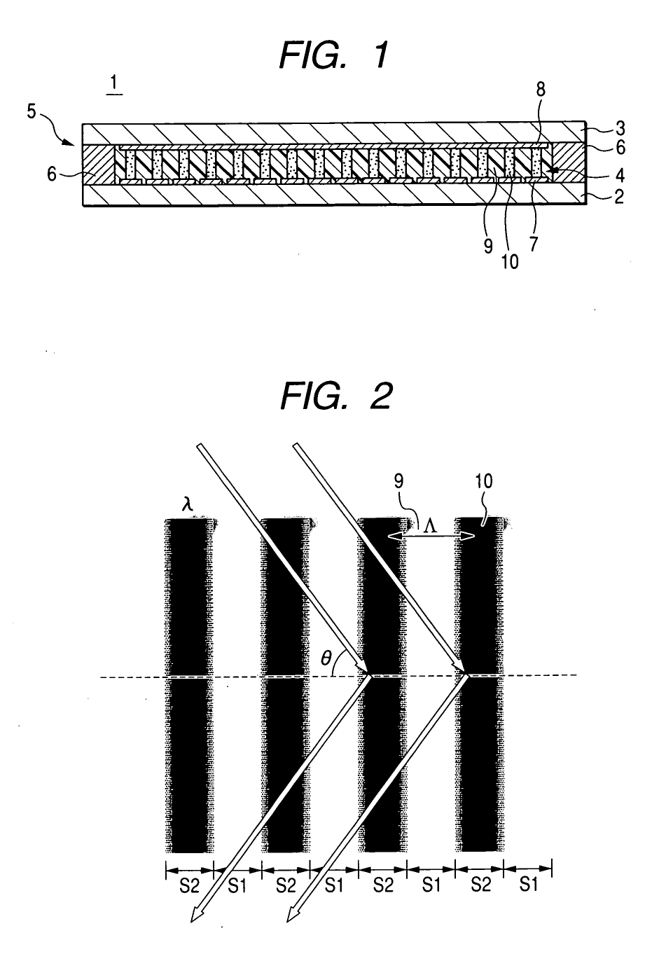

First, a holographic polymer dispersed liquid crystal device (hereinafter, referred to as a HPDLC device) 1, which is a first embodiment and is shown in FIG. 1, according to the invention will be described.

The HPDLC device 1 includes a liquid crystal cell 5 in which a polymer dispersed liquid crystal layer 4 is interposed between a pair of transparent substrates 2 and 3 disposed so as to face each other. In addition, the circumference of the pair of transparent substrates 2 and 3 is sealed by a sealant 6, and transparent electrodes 7 and 8 made of a transparent conductive material are formed on the inner surfaces, which face each other, of the pair of transparent substrates 2 and 3, respectively.

One of the transparent electrodes 7 and 8 is a stripe electrode, which is arrayed in the shape of plural stripes with a predetermined gap. The other may be a solid electrode formed on the entire substrate, and may be a stripe electrode, which is arrayed in the shape of plural stripes with a predetermined gap. When each of the transparent electrodes 7 and 8 is composed of the stripe electrode, the transparent electrodes are disposed so as to be overlapped in the thickness direction of the liquid crystal cell 5. Each of gaps between the stripe electrodes has a width corresponding to resolution of the liquid crystal cell 5.

The polymer dispersed liquid crystal layer 4 has a structure in which photo-curable resins (polymer resins) 9 and liquid crystals 10 are periodically arrayed. The photo-curable resins are polymerized and hardened by a light component having a first wavelength. Specifically, as shown in FIG. 2, the polymer dispersed liquid crystal layer 4 has a fine periodic array (diffraction grating) structure in which stripe-shaped first areas S1 and stripe-shaped second areas S2 are alternatively repeated. In the stripe-shaped first areas, there are the photo-curable resins 9, which are polymerized and hardened by a light component (ultraviolet rays) having a first wavelength, in the high density. In the stripe-shaped second areas, there are liquid crystals 10 in the high density. The first areas S1 of them have isotropic indexes of refraction due to the photo-curable resins 9, and the second areas S2 have anisotropic indexes of refraction due to the liquid crystals 10.

The liquid crystals 10 constituting the second areas S2 are nematic liquid crystals, which have positive or negative dielectric anisotropy. The oriented state of the liquid crystals is varied in response to an electric field due to the dielectric anisotropy of the liquid crystal molecules thereof. That is, when the electric field is applied to the liquid crystals 10, if the liquid crystal molecules have positive dielectric anisotropy, the liquid crystal molecules move in a direction parallel to the direction of the electric field. If the liquid crystal molecules have negative dielectric anisotropy, the liquid crystal molecules move in a direction perpendicular to the direction of the electric field. Accordingly, it is possible to vary the index of refraction of each second area S2 by the electric field applied between the transparent electrodes 7 and 8. Meanwhile, for example, a PDLC disclosed in JP-T-2000-515996 can be used as the polymer dispersed liquid crystal layer 4.

In addition, the polymer dispersed liquid crystal layer 4 contains a fluorescence agent to be described below which facilitates the hardening of the photo-curable resins 9. The fluorescence agent is a material fluorescing by a light component having a second wavelength. Specifically, the polymer dispersed liquid crystal layer 4 contains a fluorescence agent, which fluoresces by a light component (that is, ultraviolet rays) having the same wavelength as the first wavelength. The light component having the first wavelength is used to harden the photo-curable resins 9 through photo polymerization. For example, BBOT shown by the following chemical formula 1, or 5-cyanoterphenyl (5CT) shown by the following chemical formula 2 can be used as the fluorescence agent.

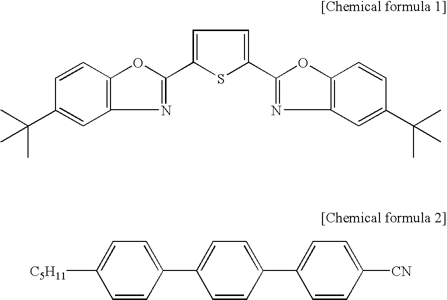

Furthermore, in some cases, the polymer dispersed liquid crystal layer 4 can contain a fluorescence agent, which fluoresces by a light component having a second wavelength different from the first wavelength. In this case, when the photo-curable resins 9 to be described below is hardened through photo polymerization, the light components having the first and the second wavelengths are radiated to the liquid crystal cell 5.

When voltage is applied between the transparent electrodes 7 and 8 of the-liquid crystal cell 5, and voltage is not applied between the transparent electrodes 7 and 8 of the liquid crystal cell 5 in the HPDLC device 1 having the above-mentioned structure, it is possible to the vary diffraction efficiency of the light passing through the liquid crystal cell 5.

Here, as shown in FIG. 2, when voltage is not applied between the transparent electrodes 7 and 8 of the liquid crystal cell 5 in the above-mentioned polymer dispersed liquid crystal layer 4, the first areas S1 have indexes of refraction different from those of the second areas S2 so as to satisfy a Bragg's condition of diffraction shown by the following expression (1).
2A cos θ=k (1)

Furthermore, in the expression (1), A represents a refraction index distribution period of the polymer dispersed liquid crystal layer 4, and θ represents an angle between the trajectory of incident light in the polymer dispersed liquid crystal layer 4 and the plane having the same index of refraction in the polymer dispersed liquid crystal layer 4. λ represents an effective wavelength in the polymer dispersed liquid crystal layer 4. In addition, the plane having the same index of refraction means a plane on which the index of refraction in the refraction index distribution is identical and continuous, for example, at the time of applying voltage to the polymer dispersed liquid crystal layer 4.

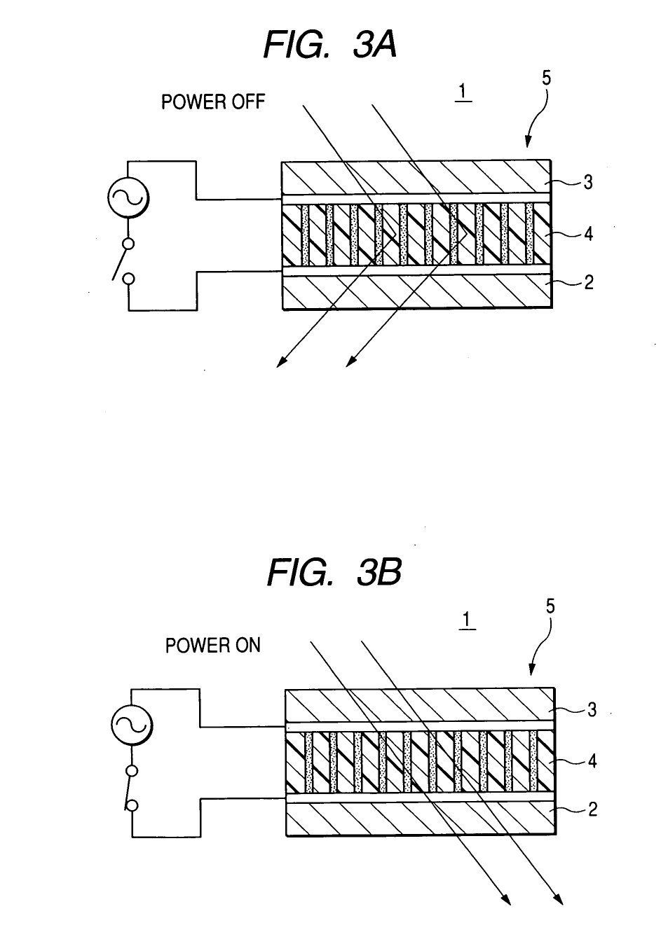

Accordingly, as shown in FIG. 3A, when voltage is not applied between the transparent electrodes 7 and 8 of the liquid crystal cell 5, the incident light L entering the liquid crystal cell 5 is strongly diffracted in the polymer dispersed liquid crystal layer 4 according to the Bragg's condition of diffraction. As a result, the diffracted light L′ passes through the liquid crystal cell 5.

In contrast, as shown in FIG. 3B, when voltage is applied between the transparent electrodes 7 and 8 of the liquid crystal cell 5, the electric field is applied to the polymer dispersed liquid crystal layer 4. Accordingly, the oriented state of the liquid crystals 10 constituting the second areas S2 is varied, and then the indexes of refraction in the second areas S2 become substantially equal to those in the first areas S1. In this case, the incident light L entering the liquid crystal cell 5 is not diffracted in the polymer dispersed liquid crystal layer 4 out of the Bragg's condition of diffraction, and then directly passes through the liquid crystal cell 5.

As described above, in the HPDLC device 1, it is possible to vary the diffraction efficiency of the light from the light transmitting state without applying voltage to the light diffraction state with applying voltage.

Furthermore, the HPDLC device 1 is not necessarily limited to a structure for varying the diffraction efficiency of the light from the light transmitting state without applying voltage to the light diffraction state with applying voltage. If the indexes of refraction in the liquid crystals 10 are set so as to satisfy the Bragg's condition of diffraction at the time of applying voltage, the HPDLC device 1 can have a structure, which varies the diffraction efficiency of the light from the light diffraction state with applying voltage to the light transmitting state without applying voltage.

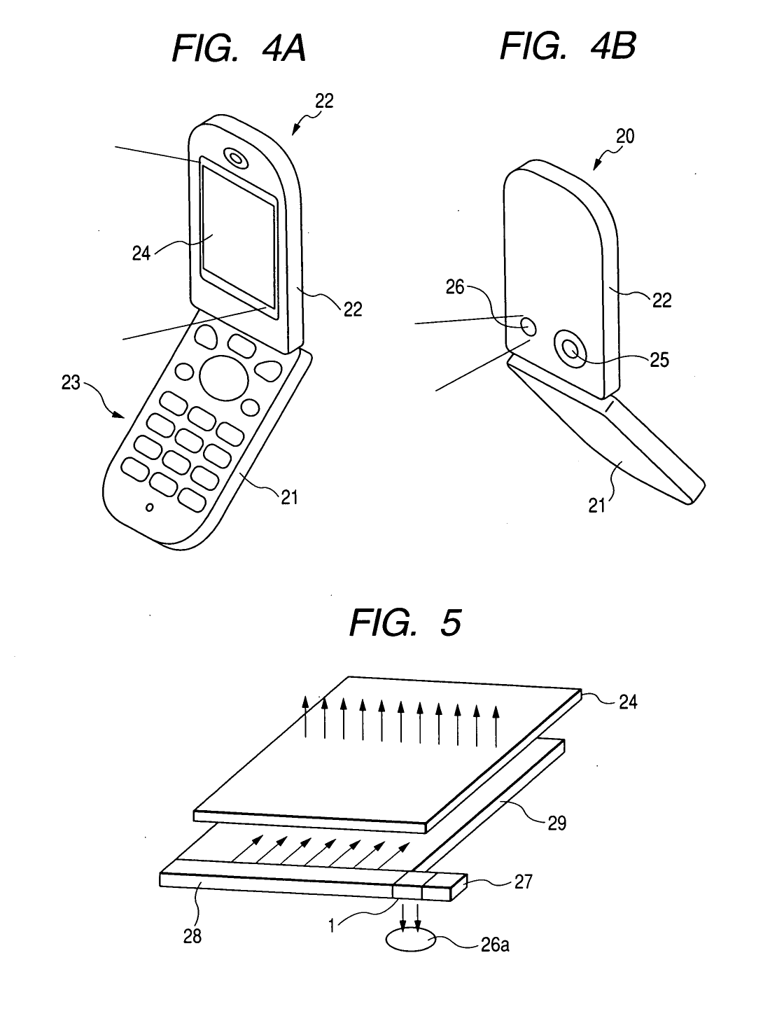

In the invention, the above-mentioned HPDLC device 1 can be used as, for example, a light path switch. Specifically, a mobile phone 20 shown in FIGS. 4A and 4B will be described as an example of an electronic device in which the HPDLC device 1 is used as a light path switch.

The mobile phone 20 has a structure in which a panel unit 22 is mounted to a main body unit 21 so as to open and close the main body unit. The main body unit 21 is provided with operation buttons 23 used to perform various operations. Furthermore, although not shown, microcomputers (CPUs) for controlling each unit and memories for storing data are provided in the main body unit 21. Meanwhile, the panel unit 22 is provided with a liquid crystal display panel 24, and states of the operations performed by the operation buttons 23 or picture image data stored in the memories are displayed on the panel unit under the control of the CPUs. In addition, a camera 25 and a flash 26 are provided on the opposite side to the liquid crystal display panel 24 in the panel unit 22. Accordingly, when the operation buttons 23 are operated, it is possible to display picture images photographed by the camera 25 on the liquid crystal display panel 24.

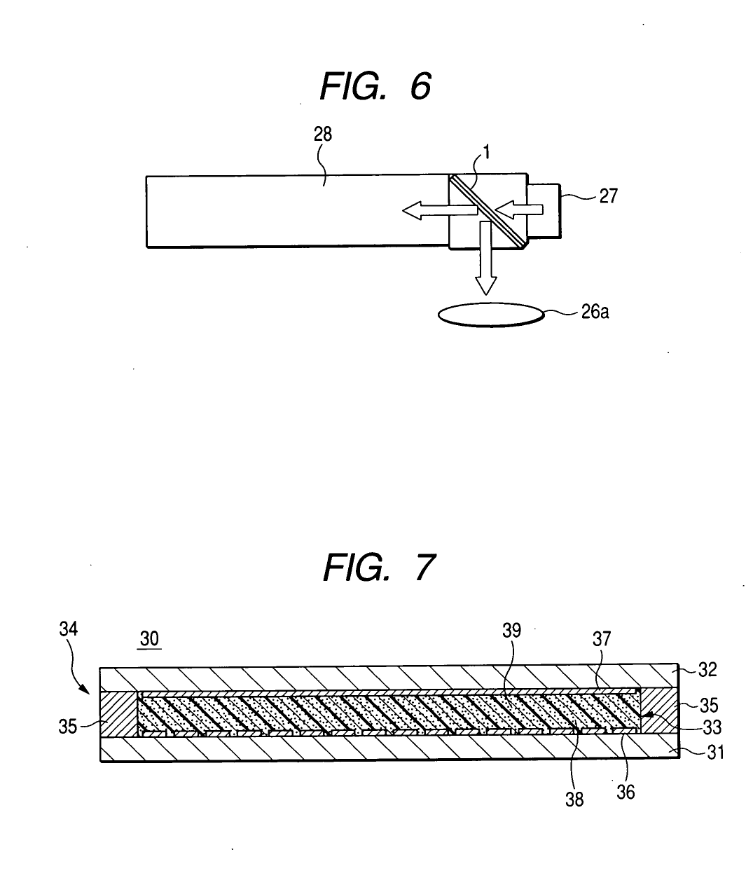

As shown in FIGS. 5 and 6, the panel unit 22 includes a light source 27, which emits light and serves as a backlight of the liquid crystal display panel 24, and a light guiding bar 28 for transmitting the light emitted from the light source 27, and a light guide plate 29. The light guide plate guides the light emitted from the light guiding bar 28 to the inside thereof from the side end surface thereof, and uniformly emits the light in the form of surface emission. Then, the light guide plate radiates the light to the rear side of the liquid crystal display panel 24. In addition, the HPDLC device 1 is provided between the light source 27 and the light guiding bar 28. The HPDLC device serves as a light path switch, which changes a light path of the light emitted from the light source 27 toward the liquid crystal display panel 24 and the flash 26.

In the mobile phone 20, when the camera 25 does not perform photography, the HPDLC device 1 is in the OFF state. In this case, the light emitted from the light source 27 directly passes through the liquid crystal cell 5, and then is transmitted to the light guiding bar 28. Meanwhile, when the camera 25 performs photography, the HPDLC device 1 is in the ON state by the operations of the operation buttons 23. In this case, the light emitted from the light source 27 is diffracted by the HPDLC device 1, and then is transmitted to a lens 26a of the flash 26. Accordingly, the mobile phone 20 can perform flash photography by the light source 27 of the backlight without providing a new light source to the flash 26.

Next, a method of manufacturing the HPDLC device 1 will be described.

When the HPDLC device 1 is manufactured, first, the liquid crystal cell 5 in which the circumference of the pair of transparent substrates 2 and 3 is sealed by the sealant 6 is prepared. Then, mixed liquor (hereinafter, referred to as syrup) is injected into the liquid crystal cell 5. Non-hardened photo-curable resins 9, which include a photo polymerization material called as a monomer or oligomer and a photo polymerization initiator for absorbing ultraviolet rays as main components, liquid crystals 10, and the fluorescence agent are compounded in a predetermined ratio and sufficiently agitated to manufacture the mixed liquor.

Next, two beams (that is, ultraviolet rays) are radiated to the liquid crystal cell 5, into which the syrup is injected, in order to harden the photo-curable resins 9 in the syrup while interfering with each other by interference exposure according to a two-beam interference exposure method.

Here, since both the photo polymerization material and the liquid crystals in the syrup are materials having polarity, they have characteristic to be easily mixed each other. However, as the photo polymerization proceeds, phase separation is generated between the polymer resins without polarity and the liquid crystals with polarity. Accordingly, in the interference exposure, the stripe-shaped first areas S1, on which hardened photo-curable resins (polymer resins) 9 are formed in the high density, are formed at bright portions, and the stripe-shaped second areas S2, on which liquid crystals 10 are formed in the high density, are formed at dark portions to generate photo polymerization reactions at the bright portions of interference fringes of the two beams.

For this reason, it is possible to form the polymer dispersed liquid crystal layer 4 having a structure, in which the hardened photo-curable resins 9 and the liquid crystals 10 are periodically arrayed, between the pair of transparent substrates 2 and 3.

Meanwhile, the syrup injected into the liquid crystal cell 5 contains a fluorescence agent fluorescing by ultraviolet rays. The BBOT shown by the above-mentioned chemical formula 1, or the 5-cyanoterphenyl (5CT) shown by the above-mentioned chemical formula 2 can be used as the fluorescence agent.

Accordingly, when the ultraviolet rays are radiated to the liquid crystal cell 5, it is possible to harden the photo-curable resins 9 with smaller energy than that used in the related art in order to facilitate the hardening of the photo-curable resins 9 by the light emitted from the fluorescence agent, and the hardening of the photo-curable resins 9 proceeds in a short time. As a result, it is possible to considerably reduce the time required to manufacture the HPDLC device 1.

Furthermore, the polymer dispersed liquid crystal layer 4 contains a fluorescence agent for fluorescing by a light component having the second wavelength different from a light component having the first wavelength, which is used to harden the photo-curable resins 9 through photo polymerization. In this case, when the photo-curable resins 9 is hardened through photo polymerization, it is possible to harden the photo-curable resins 9 with smaller energy and in a shorter time than those used in the related art by radiating the light components having the first and second wavelengths to the liquid crystal cell 5.

### Second Embodiment

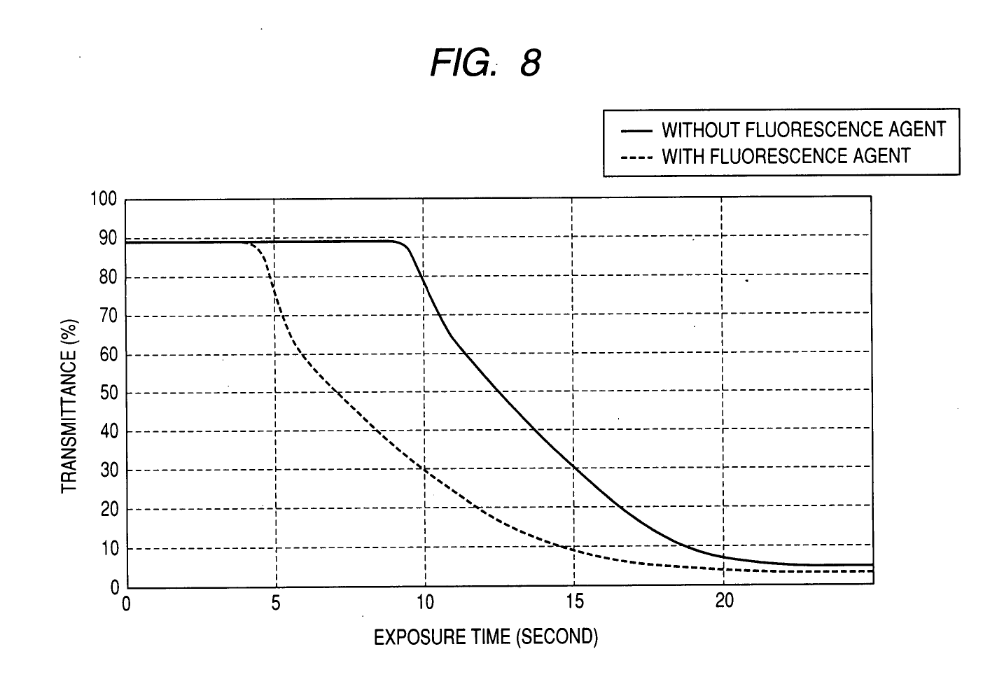

Next, the polymer dispersed liquid crystal display device (hereinafter, referred to as a PDLC display device) 30 according to the invention shown in FIG. 7 will be described as a second embodiment.

The PDLC display device 30 includes a liquid crystal cell 34 in which a polymer dispersed liquid crystal layer 33 is interposed between a pair of transparent substrates 31 and 32 disposed so as to face each other. In addition, the circumference of the pair of transparent substrates 31 and 32 is sealed by a sealant 35, and transparent electrodes 36 and 37 made of a transparent electrode material such as ITO (Indium-Tin Oxide) are formed on the inner surfaces, which face each other, of the pair of transparent substrates 31 and 32, respectively.

When a passive matrix drive system is used in the transparent electrodes 36 and 37, the transparent electrodes 36 and 37 are stripe electrodes arrayed in the shape of plural stripes with a predetermined gap, and are disposed between the pair of transparent substrates 31 and 32 so as to be orthogonal to each other. Meanwhile, when an active matrix drive system is used in the transparent electrodes, one of the transparent electrodes 36 and 37 is a solid electrode formed on the entire substrate, and the other is a pixel electrode, which is arrayed in the shape of a matrix so as to correspond to each pixel. In addition, when the active matrix drive system is used in the transparent electrodes, lighting of each pixel is controlled by providing an active device such as a TFT (Thin Film Transistor) to each pixel.

The polymer dispersed liquid crystal layer 33 has a structure in which liquid crystals 39 are dispersed in photo-curable resins (polymer resins) 38. The photo-curable resins are polymerized and hardened by a light component having a first wavelength. The liquid crystals 39 dispersed in the photo-curable resins 38 are nematic liquid crystals, which have positive or negative dielectric anisotropy. The oriented state of the liquid crystals is varied in response to an electric field due to the dielectric anisotropy of the liquid crystal molecules thereof. That is, when the electric field is applied to the liquid crystals 39, if the liquid crystal molecules have positive dielectric anisotropy, the liquid crystal molecules move in a direction parallel to the direction of the electric field. If the liquid crystal molecules have negative dielectric anisotropy, the liquid crystal molecules move in a direction perpendicular to the direction of the electric field. Accordingly, it is possible to vary the oriented state of the liquid crystals 39 dispersed in the photo-curable resins 38 by the electric field applied between the transparent electrodes 36 and 37. Meanwhile, for example, a PDLC disclosed in JP-T-2000-515996 can be used as the polymer dispersed liquid crystal layer 33.

In addition, the polymer dispersed liquid crystal layer 33 contains a fluorescence agent to be described below which facilitates the hardening of the photo-curable resins 38. The fluorescence agent is a material fluorescing by a light component having a second wavelength. Specifically, the polymer dispersed liquid crystal layer 33 contains a fluorescence agent, which fluoresces by a light component (that is, ultraviolet rays) having the same wavelength as the first wavelength. The light component having the first wavelength is used to harden-the photo-curable resins 38 through photo polymerization. For example, BBOT shown by the above-mentioned chemical formula 1, or 5-cyanoterphenyl (5CT) shown by the above-mentioned chemical formula 2 can be used as the fluorescence agent.

Furthermore, in some cases, the polymer dispersed liquid crystal layer 33 can contain a fluorescence agent, which fluoresces by a light component having a second wavelength different from the first wavelength. In this case, when the photo-curable resins 38 to be described below is hardened through photo polymerization, the light components having the first and the second wavelengths are radiated to the liquid crystal cell 34.

When voltage is applied between the transparent electrodes 36 and 37 of the liquid crystal cell 34, and voltage is not applied between the transparent electrodes 36 and 37 of the liquid crystal cell 34 in the PDLC display device 30 having the above-mentioned structure, picture images are displayed by varying transmittance of the light component passing through the liquid crystal cell 34.

Specifically, when voltage is not applied between the transparent electrodes 36 and 37 of the liquid crystal cell 34, the liquid crystal molecules of the liquid crystals 39 dispersed in the photo-curable resins 38 are oriented in random directions with respect to each other. Therefore, the incident light L entering the liquid crystal cell 34 is scattered in the polymer dispersed liquid crystal layer.

In contrast, when voltage is applied between the transparent electrodes 36 and 37 of the liquid crystal cell 34, the electric field is applied to the polymer dispersed liquid crystal layer 33. Accordingly, the liquid crystal molecules of the liquid crystals 39 dispersed in the photo-curable resins 38 are oriented in a predetermined direction. In this case, the incident light L entering the liquid crystal cell 34 passes through the polymer dispersed liquid crystal layer 33.

As described above, in the PDLC display device 30, it is possible to vary the transmittance of the light component passing through the liquid crystal cell 34 from a light scattering state without applying voltage to a light transmitting state with applying voltage by controlling drive voltage to be applied between the electrodes of each pixel. Moreover, it is possible to display picture images by controlling lighting of each pixel. Furthermore, since the PDLC display device 30 does not require orientation of the liquid crystals 39 or polarizers, the PDLC display device can increase light use efficiency and display brighter picture images than those in the conventional liquid crystal display device such as a TN (Twisted Nematic) liquid crystal.

Meanwhile, the PDLC display device 30 can have, for example, a reflective structure in which the reflective picture images are displayed by providing a reflecting plate on the rear side of the liquid crystal cell 34 and by forming a reflecting film on the substrate provided on the rear side of the liquid crystal cell 34, in addition to a transparent structure in which the transparent picture images are displayed by radiating the light component from the rear side of the liquid crystal cell 34.

Furthermore, in the PDLC display device 30, it is possible to display the picture images by the light entering the PDLC display device from the side end surface of the liquid crystal cell 34. In this case, it is possible to reduce a size (in particular, thickness) of the entire device by providing an illuminating device for illuminating the PDLC display device 30 on the side end portion of the liquid crystal cell 34.

In addition, color filters corresponding to primary colors (that is, red, green, and blue colors) are provided on the liquid crystal cell 34, and thus the PDLC display device 30 can display color picture images. Furthermore, light sources corresponding to primary colors (that is, red, green, and blue colors) are provided to the illuminating device for illuminating the PDLC display device 30, respectively, and thus color picture images can be displayed by means of color light components emitted from the light sources.

Next, a method of manufacturing the PDLC display device 30 will be described.

When the PDLC display device 30 is manufactured, first, the liquid crystal cell 34 in which the circumference of the pair of transparent substrates 31 and 32 is sealed by the sealant 35 is prepared. Then, mixed liquor (hereinafter, referred to as syrup) is injected into the liquid crystal cell 34. Non-hardened photo-curable resins 38, which include a photo polymerization material called as a monomer or oligomer and a photo polymerization initiator for absorbing ultraviolet rays as main components, liquid crystals 39, and the fluorescence agent are compounded in a predetermined ratio and sufficiently agitated to manufacture the mixed liquor.

Next, ultraviolet rays are uniformly radiated to the entire surface of the liquid crystal cell 34, into which the syrup is injected, by overall exposure to harden the photo-curable resins 38 in the syrup through photo polymerization. For this reason, it is possible to form the polymer dispersed liquid crystal layer 33 having a structure, in which the liquid crystals 39 are dispersed in the hardened photo-curable resins (polymer resins) 38, between the pair of transparent substrates 31 and 32.

Meanwhile, the syrup injected into the liquid crystal cell 34 contains a fluorescence agent fluorescing by ultraviolet rays. The BBOT shown by the above-mentioned chemical formula 1, or the 5-cyanoterphenyl (5CT) shown by the above-mentioned chemical formula 2 can be used as the fluorescence agent.

Accordingly, when the ultraviolet rays are radiated to the liquid crystal cell 34, it is possible to harden the photo-curable resins 38 with smaller energy than that used in the related art in order to facilitate the hardening of the photo-curable resins 38 by the light emitted from the fluorescence agent, and the hardening of the photo-curable resins 38 proceeds in a short time. As a result, it is possible to considerably reduce the time required to manufacture the PDLC device 30.

Furthermore, the polymer dispersed liquid crystal layer 33 contains a fluorescence agent for fluorescing by a light component having the second wavelength different from a light component having the first wavelength, which is used to harden the photo-curable resins 38 through photo polymerization. In this case, when the photo-curable resins 38 is hardened through photo polymerization, it is possible to harden the photo-curable resins 38 with smaller energy and in a shorter time than those used in the related art by radiating the light components having the first and second wavelengths to the liquid crystal cell 34.

### EXAMPLES

### First Example

The PDLC display device 30 is actually manufactured in a first example. Specifically, when the PDLC display device of the first example is manufactured, first, the liquid crystal cell 34 in which the circumference of the pair of transparent substrates 31 and 32 is sealed by the sealant 35 is prepared. Then, the syrup is injected into the liquid crystal cell 34. The syrup is manufactured as follows: acryl based monomers serving as photo-curable resins 38, and nematic mixed liquid crystals serving as liquid crystals 39 are compounded in a ratio of 1:4, and the 5-cyanoterphenyl (5CT) serving as a fluorescence agent is added to the mixture in a ratio of 1%. Then, the mixture is sufficiently agitated to manufacture the syrup. Next, ultraviolet rays are uniformly radiated to the entire panel surface of the liquid crystal cell 34, into which the syrup is injected, by overall exposure to harden the photo-curable resins 38 in the syrup through photo polymerization. In this way, the PDLC display device 30 is manufactured. In the PDLC display device, the polymer dispersed liquid crystal layer 33, in which the liquid crystals 39 are dispersed in the hardened photo-curable resins 38, is formed between the pair of transparent substrates 31 and 32.

### First Comparative Example

A PDLC display device of a first comparative example is manufactured to be equal to the PDLC display device of the first example except for the fact that the fluorescence agent is not added to the syrup.

FIG. 8 shows results of measuring relationship between light transmittance of each cell in the first example and the first comparative example, and the exposure time of the ultraviolet rays during the manufacture thereof.

As shown in FIG. 8, when the first example and the first comparative example are compared with each other, the light transmittance of the cell in the PDLC display device according to the first example, in which the fluorescence agent is added to the syrup, is early reduced with respect to the exposure time. Accordingly, it is understood that the hardening of the photo-curable resins 38 early proceeds. Moreover, it is understood that the final light transmittance of the cell in the first example is lower than that in the first comparative example. Accordingly, it is clearly understood that the time required to manufacture the PDLC device 30 is considerably reduced and the light transmittance characteristic thereof is also improved by adding the fluorescence agent to the syrup.

### Second Example

The HPDLC device 1 is actually manufactured in a second example. Specifically, when the HPDLC device 1 of the second example is manufactured, first, the liquid crystal cell 5 in which the circumference of the pair of transparent substrates 2 and 3 is sealed by the sealant 6 is prepared. Then, the syrup is injected into the liquid crystal cell 5. The syrup is manufactured as follows: acryl based monomers serving as photo-curable resins 9, and nematic mixed liquid crystals serving as liquid crystals 10 are compounded in a ratio of 1:1, and the 5-cyanoterphenyl (5CT) serving as a fluorescence agent is added to the mixture in a ratio of 1%. Then, the mixture is sufficiently agitated to manufacture the syrup. Next, two beams (that is, ultraviolet rays) are radiated to the liquid crystal cell 5, into which the syrup is injected, in order to harden the photo-curable resins 9 in the syrup while interfering with each other by interference exposure according to a two-beam interference exposure method. In this way, the HPDLC device 1 is manufactured. In the HPDLC device, the polymer dispersed liquid crystal layer 4, in which the liquid crystals 10 are dispersed in the hardened photo-curable resins 9, is formed between the pair of transparent substrates 2 and 3.

### Second Comparative Example

A HPDLC display device of a second comparative example is manufactured to be equal to the HPDLC device of the second example except for the fact that the fluorescence agent is not added to the syrup.

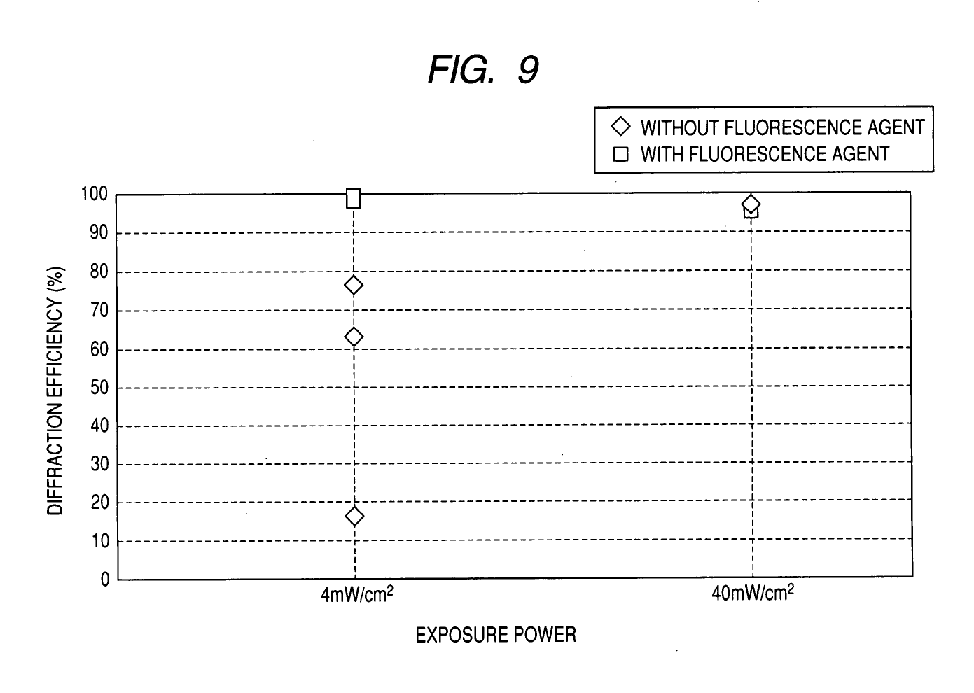

FIG. 9 shows results of measuring relationship between diffraction efficiency of each cell in the second example and the second comparative example, and the exposure power of the ultraviolet rays during the manufacture thereof.

As shown in FIG. 9, the second example and the second comparative example are compared with each other. In this case, when the exposure power is high (40 mW/cm²) and when the exposure power is low (4 mW/cm²), diffraction efficiency of nearly 100% is obtained in the HPDLC display device according to the second example in which the fluorescence agent is added to the syrup. In contrast, when the exposure power is low, it is understood that low diffraction efficiency is obtained in the HPDLC display device according to the second example in which the fluorescence agent is not added to the syrup. Accordingly, it is clearly understood that the photo-curable resins 9 can be hardened with small energy by adding the fluorescence agent to the syrup.

### Third Example

A PDLC display device of a third example is manufactured to be equal to the PDLC device of the first example except for the fact that BBOT of 0.5% is added to the syrup as a fluorescence agent.

### Fourth Example

A PDLC display device of a fourth example is manufactured to be equal to the PDLC device of the third example except for the fact that BBOT of 2.0% is added to the syrup as a fluorescence agent.

### Third Comparative Example

A PDLC display device of a third comparative example is manufactured to be equal to the PDLC device of the third example except for the fact that BBOT is not added to the syrup.

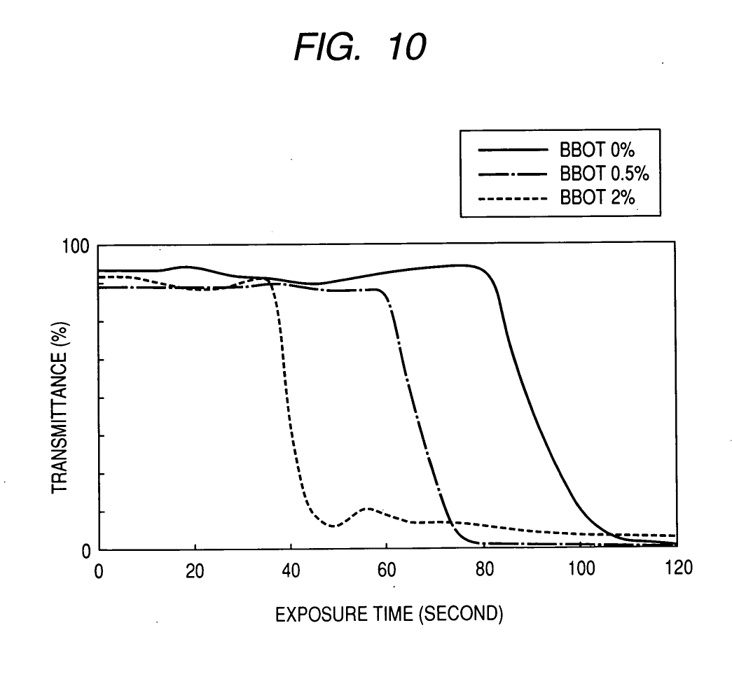

FIG. 10 shows results of measuring relationship between light transmittance of each cell in the third and fourth examples and the third comparative example, and the exposure time of the ultraviolet rays during the manufacture thereof.

As shown in FIG. 10, when the third and fourth examples and the third comparative example are compared with one another, the light transmittances of the cells in the PDLC display devices according to the third and fourth examples, in which BBOT is added to the syrup, are early reduced with respect to the exposure time, respectively. Accordingly, it is understood that the hardening of the photo-curable resins early proceeds. Meanwhile, when the third and fourth examples are compared with each other, the light transmittance of the cell in the PDLC display device according to the fourth example, in which more BBOT is added to the syrup, is early reduced with respect to the exposure time. Accordingly, it is understood that the hardening of the photo-curable resins early proceeds. Moreover, it is understood that the final light transmittance of the cell in the third example in which less BBOT is added to the syrup is lower than that in the fourth comparative example. Accordingly, it is clearly understood that the time required to manufacture the PDLC device 30 is considerably reduced and the light transmittance characteristic thereof is also improved by adding BBOT to the syrup as a fluorescence agent.

As described above, according to the invention, the mixed liquor injected into the liquid crystal cell contains a material for fluorescing by the light components having the second wavelength. Accordingly, when the light components having the first and the second wavelengths are radiated to the liquid crystal cell, it is possible to harden the photo-curable resins with smaller energy than that used in the related art, and the hardening of the photo-curable resins can proceeds in a short time. As a result, it is possible to considerably reduce the time required to manufacture the polymer dispersed liquid crystal device.

1. A polymer dispersed liquid crystal device comprising:
a liquid crystal cell in which the circumference of a pair of substrates is sealed by a sealant; and
a polymer dispersed liquid crystal layer that includes photo-curable resins and liquid crystals, and is provided between the pair of substrates of the liquid crystal cell, the photo-curable resins and liquid crystals being polymerized and hardened by a light component having a first wavelength,
wherein the polymer dispersed liquid crystal layer contains a material for fluorescing by a light component having a second wavelength.

2. The polymer dispersed liquid crystal device according to claim 1,
wherein the first wavelength and the second wavelength are equal to each other.

3. The polymer dispersed liquid crystal device according to claim 1,
wherein the polymer dispersed liquid crystal layer has a structure in which the liquid crystals are dispersed in the hardened photo-curable resins.

4. The polymer dispersed liquid crystal device according to claim 1,
wherein the polymer dispersed liquid crystal layer has a structure in which the liquid crystals and the hardened photo-curable resins are periodically arrayed.

5. A method of manufacturing a polymer dispersed liquid crystal device, comprising steps of:
radiating a light component having a first wavelength to a liquid crystal cell in which a mixed liquor of liquid crystals and non-hardened photo-curable resins is injected between a pair of substrates; and
forming a polymer dispersed liquid crystal layer, which includes hardened photo-curable resins and the liquid crystals, by hardening the photo-curable resins through photo polymerization,
wherein the mixed liquor contains a material for fluorescing by a light component having a second wavelength.

6. The method of manufacturing a polymer dispersed liquid crystal device according to claim 5,
wherein the first wavelength and the second wavelength are equal to each other.

7. The method of manufacturing a polymer dispersed liquid crystal device according to claim 5,
wherein the polymer dispersed liquid crystal layer in which the liquid crystals are dispersed in the hardened photo-curable resins is formed by performing overall exposure with light components having the first and second wavelengths.

8. The method of manufacturing a polymer dispersed liquid crystal device according to claim 5,
wherein the polymer dispersed liquid crystal layer in which the liquid crystals and the hardened photo-curable resins are periodically arrayed is formed by performing interference exposure with light components having the first and second wavelengths.
